(19) United States
(12) Patent Application Publication
(10) Pub. No.: US 2014/0007851 A1
(43) Pub. Date: Jan. 9, 2014

(54) METHOD OF CONTROLLING AN AFTER-TREATMENT SYSTEM WARM-UP

(71) Applicant: GM GLOBAL TECHNOLOGY OPERATIONS LLC, Detroit, MI (US)

(72) Inventors: Alberto VASSALLO, Torino (IT); Hans DRANGEL, Torino (IT); Federico LUIGI GUGLIELMONE, Rivoli (IT)

(21) Appl. No.: 13/935,118

(22) Filed: Jul. 3, 2013

(30) Foreign Application Priority Data
Jul. 5, 2012 (GB) 1212022.6

(51) Int. Cl. F02M 25/07

(52) U.S. Cl. CPC F02M 25/07
USPC 123/568.11

(57) ABSTRACT

A method is provided for controlling an internal combustion engine. The engine includes, but is not limited to a low pressure EGR cooler by-pass circuit, and a control valve. The method controls the opening of the EGR cooler by-pass circuit with the control valve, if enabling conditions are met.

### CROSS-REFERENCE TO RELATED APPLICATION

This application claims priority to British Patent Application No. 1212022.6, filed Jul. 5, 2012, which is incorporated herein by reference in its entirety.

### TECHNICAL FIELD

The technical field relates to a method of controlling the warm up of an after-treatment system for internal combustion engines, particularly for engines provided with a low pressure exhaust gas recirculation system (LP-EGR).

### BACKGROUND

An internal combustion engine, particularly a highly efficient diesel engine is normally provided with an exhaust gas after-treatment system, for degrading and/or removing the pollutants from the exhaust gas emitted by the Diesel engine, before discharging it in the environment. The after-treatment system generally comprises an exhaust line for leading the exhaust gas from the Diesel engine to the environment, a Diesel Oxidation Catalyst (DOC) located in the exhaust line, for oxidizing hydrocarbon (HC) and carbon monoxides (CO) into carbon dioxide (CO2) and water (H2O), and a Diesel Particulate Filter (DPF) located in the exhaust line downstream the DOC, for removing diesel particulate matter or soot from the exhaust gas.

Another well-known exhaust gas after-treatment system of a Diesel engine is the Lean NOx Trap (LNT), which is provided for trapping nitrogen oxides NOx contained in the exhaust gas and is located in the exhaust line. A LNT is a catalytic device containing catalysts, such as Rhodium, Platinum and Palladium, and adsorbents, such as barium based elements, which provide active sites suitable for binding the nitrogen oxides (NOx) contained in the exhaust gas, in order to trap them within the device itself Lean NOx Traps (LNT) are subjected to periodic regeneration processes, whereby such regeneration processes are generally provided to release and reduce the trapped nitrogen oxides (NOx) from the LNT.

Although these devices are currently among the most promising for controlling exhaust emissions, they are not effective until they are heated to a predefined operating or activation temperature.

Nowadays, the need for improving vehicle fuel economy will lead to a widespread reduction of vehicle mass and drag resistance, as well as to usage of highly-efficient engines, particularly high speed diesel engines. The combination of the above-mentioned trends will lead to a huge reduction of exhaust temperature levels, which in turn will slow the warm-up and the light-off of the after-treatment systems. This in turn will imply that unburned HC and CO emissions would be penalized by later DOC light-off, and the DPF regeneration would require more time to be effective.

Actually, the known methods to accelerate the engine warm up are based on the use of the high pressure EGR cooler by-pass and/or the intercooler by-pass. For instance, in U.S. Pat. No. 7,007,680 it is used a charge-air cooler and/or EGR cooler by-pass system that can control the intake manifold temperature above the dew-point temperature of the boosted air. Another example is known from DE112006003134, which discloses an exhaust gas recirculation by-pass passage, operable for receiving exhaust gas from an exhaust line, bypassing the EGR cooler, and delivering the exhaust gas to an intake (14), as well as a single valve operably associated with the exhaust gas recirculation cooler and the exhaust gas recirculation by-pass passage. The single valve is selectively operable for opening or closing flow from the exhaust to the exhaust gas recirculation cooler, the exhaust gas recirculation by-pass passage.

The main drawback of the known system is that they are operating with high pressure EGR systems which, as known, decrease the flow through the after-treatment, effect which is not beneficial for fastening the after-treatment warm-up. Therefore a need exists for a method of controlling the internal combustion engine, which effectively provides an earlier after-treatment system warm up, thus improving the emission level but also the fuel consumption and the oil dilution as well.

Accordingly, at least one object is to provide a method that improves the engine warm up by controlling with a new strategy the LP-EGR recirculation in LP-EGR cooler by-pass mode, eventually coupled to an intercooler by-pass, in order to significantly increase the engine-out temperature level as well the exhaust flow rate in the after-treatment during those phases. At least another object is to provide an apparatus that performs the above method. In addition, other objects, desirable features, and characteristics will become apparent from the subsequent summary and detailed description, and the appended claims, taken in conjunction with the accompanying drawings and this background.

### SUMMARY

An embodiment provides a method of controlling an internal combustion engine, the engine comprising a low pressure EGR cooler by-pass circuit and a control valve, the method controlling the opening of said EGR cooler by-pass circuit by means of said control valve, if enabling conditions are met. Consequently, an apparatus is disclosed for controlling an internal combustion engine, the apparatus comprising means for controlling the opening of said EGR cooler by-pass circuit by means of said control valve, if enabling conditions are met. At least one advantage of this embodiment is that it provides a method that allows a quicker after-treatment warm-up and, therefore, unburned HC and CO emissions would benefit from earlier DOC light-off and the DPF regeneration could be made more robust and shorter as well.

According to another embodiment, the internal combustion engine further comprises an intercooler by-pass circuit and a control valve, the method further controlling the opening of said intercooler by-pass circuit with said control valve, if an enabling condition is met. At least one advantage of this embodiment is that it provides a method that allows an even quicker after-treatment warm-up.

According to a further embodiment the enabling conditions are: active regeneration of a particulate filter or engine warm-up, inlet oxidation catalyst temperature below an inlet oxidation catalyst temperature target, an outlet compressor temperature below a threshold TH1. These enabling criteria are preferred conditions for the method to be applied, since the enable the maximum efficiency of the strategy, without penalizing engine safety conditions.

According to a still further embodiment, the enabling condition requires the intake manifold temperature below a threshold TH2. Also according to this embodiment the chosen criterion guarantees the maximum efficiency of the strategy, without penalizing the engine charging conditions.

According to another embodiment, an internal combustion engine is provided for an automotive system. The engine comprises a low pressure EGR valve, a low pressure EGR cooler, an EGR cooler by-pass circuit, and a control valve. The automotive system is configured for carrying out the above method.

According to a still further embodiment, an internal combustion engine is provided for an automotive system. The engine further comprises an intercooler, an intercooler by-pass circuit and a control valve, the automotive system that configured for carrying out the above method.

The method according to an embodiment is carried out with the help of a computer program comprising a program-code for carrying out all the steps of the method described above, and in the form of computer program product comprising the computer program. The computer program product can be embodied as a control apparatus for an internal combustion engine, comprising an Electronic Control Unit (ECU), a data carrier associated to the ECU, and the computer program stored in a data carrier, so that the control apparatus defines the embodiments described in the same way as the method. In this case, when the control apparatus executes the computer program all the steps of the method described above are carried out.

The method according to a further embodiment can be also embodied as an electromagnetic signal, the signal being modulated to carry a sequence of data bits which represents a computer program to carry out all steps of the method. A still further embodiment provides an internal combustion engine specially arranged for carrying out the method claimed.

### BRIEF DESCRIPTION OF THE DRAWINGS

The present invention will hereinafter be described in conjunction with the following drawing figures, wherein like numerals denote like elements, and:

FIG. 1 shows an automotive system;

FIG. 2 is a section of an internal combustion engine belonging to the automotive system of FIG. 1;

FIG. 3 is a scheme of an internal combustion engine comprising an EGR cooler by-pass and an intercooler by-pass, according to an embodiment;

FIG. 4 is a flowchart of a method of controlling an internal combustion engine, according to an embodiment; and

FIG. 5 is an example of a map for acquiring a target temperature at oxygen catalyst inlet T_{DOC,target}.

### DETAILED DESCRIPTION OF THE DRAWINGS

The following detailed description is merely exemplary in nature and is not intended to limit application and uses. Furthermore, there is no intention to be bound by any theory presented in the preceding background or summary or the following detailed description.

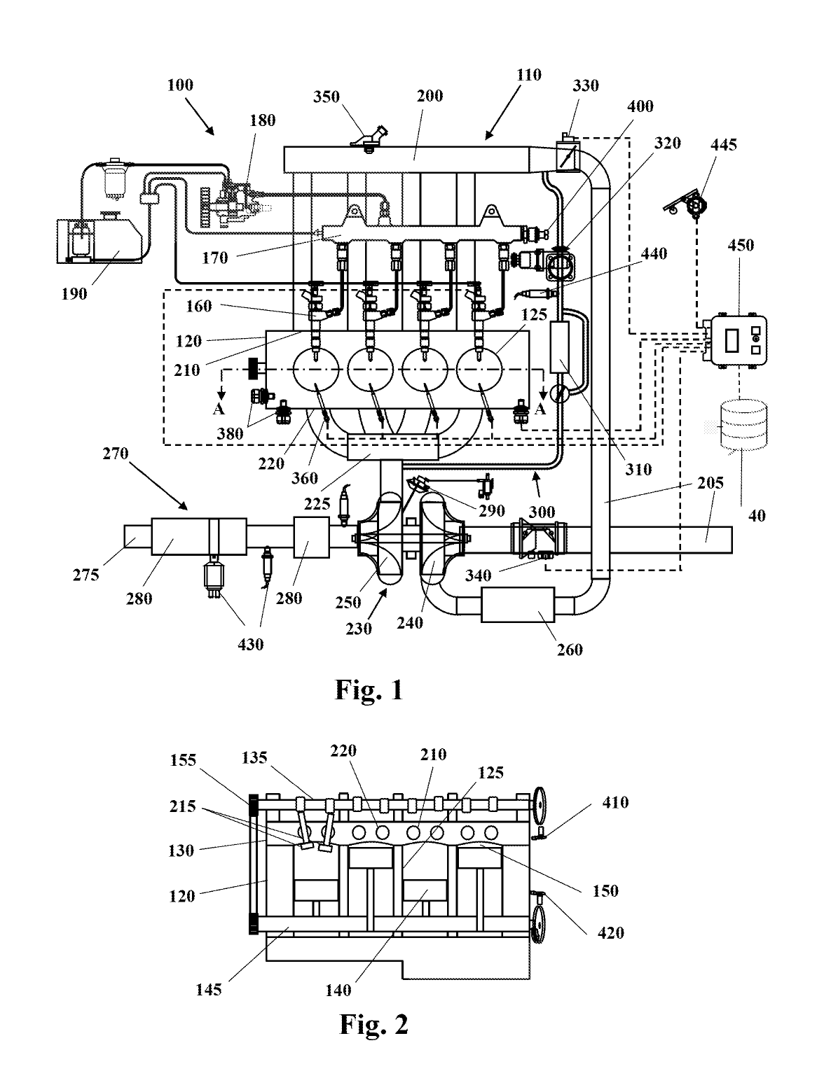

Some embodiments may include an automotive system 100, as shown in FIG. 1 and FIG. 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increase the pressure of the fuel received a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

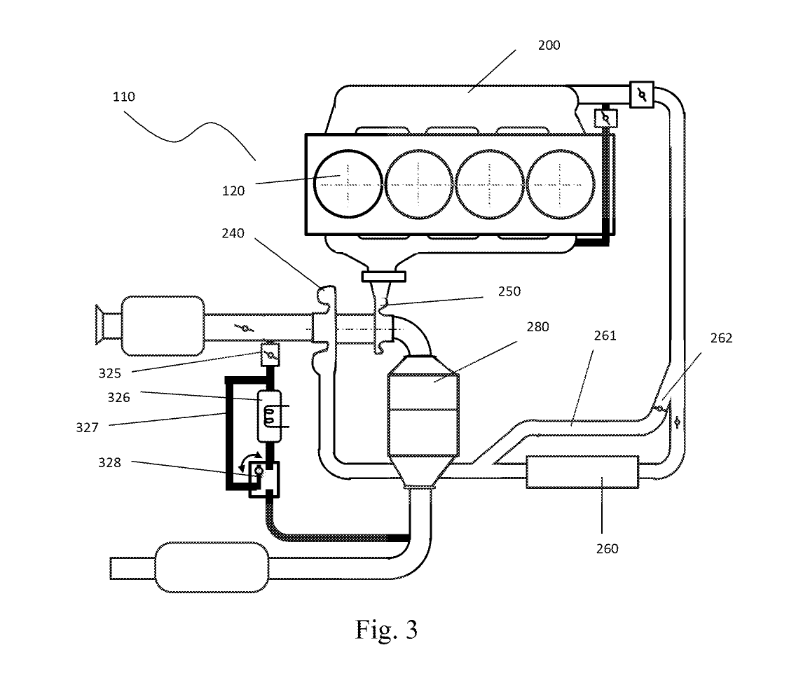

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The intercooler 260 can also be provided (see FIG. 3) with an intercooler by-pass circuit 261 and a control valve 262. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. This example shows a variable geometry turbine (VGT) 250 with a VGT actuator 290 arranged to move the vanes to alter the flow of the exhaust gases through the turbine 250. In other embodiments, the turbocharger 230 may be fixed geometry and/or include a waste gate.

The exhaust system 270 may include an exhaust pipe 275 having one or more exhaust after-treatment devices 280. The after-treatment devices may be any device configured to change the composition of the exhaust gases. Some examples of after-treatment devices 280 include, but are not limited to, catalytic converters (two and three way), oxidation catalysts 281, lean NOx traps, hydrocarbon absorbers, selective catalytic reduction (SCR) systems, particulate filters (DPF) 282 or a combination of the last two devices, i.e., selective catalytic reduction system comprising a particulate filter (SCRF). Some embodiments include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300. Still other embodiments (FIG. 3) may include a low pressure EGR system (LP-EGR) characterized by a “long route” of the exhaust gases. In this case, an additional low pressure EGR valve 325 will recirculate the exhaust gases downstream the after-treatment devices towards the compressor 240 inlet. Moreover, a low pressure EGR-cooler 326 can be provided, together with a cooler by-pass circuit 327 and a control valve 328.

The automotive system 100 may further include an electronic control unit (ECU) 450 in communication with one or more sensors and/or devices associated with the ICE 110 and equipped with a data carrier 40. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445. Furthermore, the ECU 450 may generate output signals to various control devices that are arranged to control the operation of the ICE 110, including, but not limited to, the fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carryout out the steps of such methods and control the ICE 110.

The method according is related to the control of the engine warm-up, with one or, alternatively, two cooler by-passes: a low pressure EGR cooler by-pass and an intercooler by-pass. A low pressure EGR system, also called “long route” EGR system, is the one showed in FIG. 3. The term low pressure, as known, means that the exhaust gases are also recirculated downstream the after-treatment devices through a low pressure EGR valve 325 to the inlet system, upstream the compressor 240. The LP-EGR system is normally provided with an EGR cooler 326 and the proposed technique involves the employment of a specific component to be added to the conventional LP-EGR currently known: it is LP-EGR cooler by-pass 327, provided with a control valve 328.

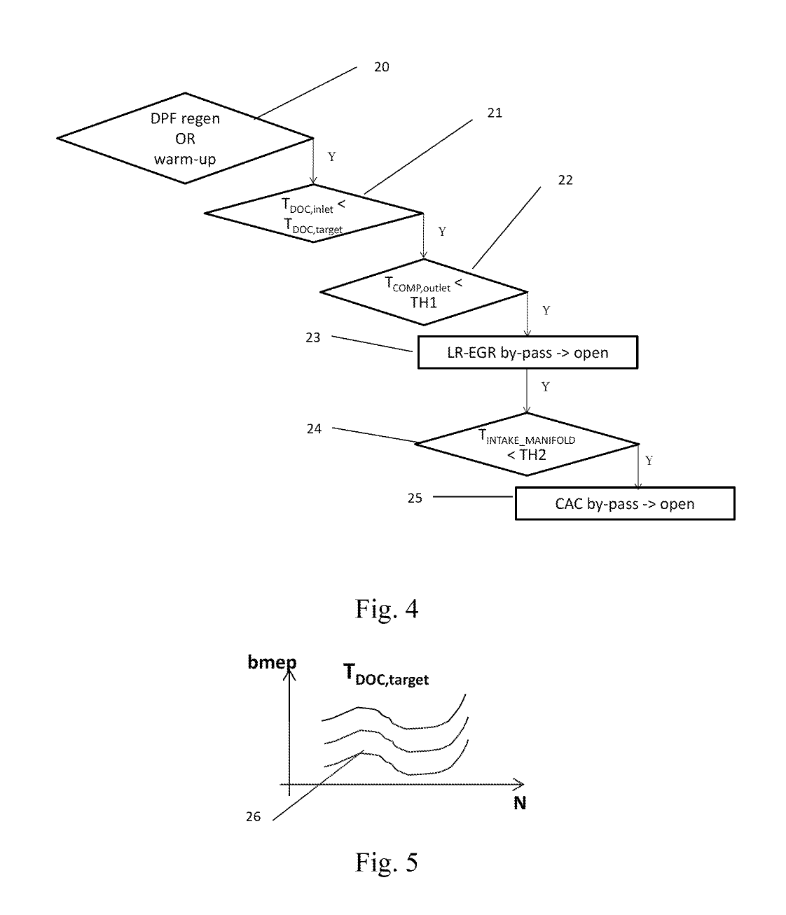

According to an embodiment, the use of a second by-pass, that is the intercooler (or charge air cooler) by-pass 261, provided with a control valve 262. The appropriate control strategies to coordinate their operation are part of this invention as well (see FIG. 4). They are activated when some enabling conditions are met. First of all the engine operating mode should be the following: engine warm-up or DPF regeneration active. Then, the exhaust temperature level should be below a threshold. If these conditions are satisfied, an after-treatment accelerated warm-up strategy is triggered. In fact, the LP-EGR cooler by-pass 327 is activated (or the former and the intercooler by-pass 261 are activated in coordination), in order to increase the intake manifold temperature and hence the exhaust temperature level at the oxidation catalyst inlet or, in other embodiments, at the inlet of a lean NOx trap. To this end, the two on/off control valves 328, 262 for the by-pass channels are opened, both on the LP-EGR cooler by-pass 327 and on the charge air cooler 261. This strategy, compared with the one using a conventional high pressure EGR by-pass mode, increases the exhaust flow rate through the after-treatment, as the EGR gas is taken downstream the after-treatment system. In fact, as known, for a high pressure EGR system 300, also called “short route” EGR system, the term high pressure means the exhaust gases are recirculated from the exhaust system 270 (upstream the turbine 250) to the intake manifold 200, downstream the compressor 240 and consequently the exhaust gas flow rate, passing through the after-treatment system is lower.

Of course, for avoiding extra heat-up, several thresholds for temperature are foreseen: at the compressor 240 outlet, at the inlet of the intake manifold 200 and at the oxygen catalyst 281 inlet. Once the heat-up strategy has reached the desired oxidation catalyst 281 (or the lean NOx trap) inlet temperature level for a proper amount of time or the DPF 282 regeneration strategy is terminated, the normal operation is restored and the by-passes are closed.

Going more into details of the enabling conditions, the first condition to be checked concerns the engine operating status: of course, the strategy only applies if a DPF 282 regeneration status or an engine warm-up are detected, according to engine status variables already available into the ECU 450 (for example, a flag showing that DPF regeneration is active or an engine temperature). The second condition relates to the after-treatment status: the temperature at the oxygen catalyst inlet, TDOC, inlet should be lower than a target map temperature TDOC, target for a certain engine operating point. In FIG. 5 an example of such map is shown: TDOC, target 26 is function of the engine speed N and the engine load, or brake mean effective pressure bmep. An average value of the TDOC, target map is around 200° C. If this condition is satisfied, then the third condition relates to the compressor outlet temperature TCOMP, outlet is checked: if the temperature at the compressor outlet is lower than an acceptable threshold TH1 (to protect safe compressor operation this value should not overcome 200° C.), the LP-EGR cooler by-pass 327, with its control valve 328, can be activated, thus also raising the temperatures at compressor 240 outlet.

Then, if also the intercooler by-pass is available, a fourth condition is checked for making sure that the temperature in the intake manifold 200 TINTAKE_MANIFOLD is below an acceptable threshold TH2 (to protect the intake manifold itself, the temperature should not overcome about 70° C.). If this condition is also satisfied, the intercooler by-pass 261, with its control valve 262, can be activated as well, thus raising further the temperature of the intake charge and, as a consequence, of the exhaust gases.

Summarizing, the proposed technique improves the current strategies for engine warm-up, by using a long-route EGR system layout and adding one cooler by-pass 327 and the related control valve 328 to the LP-EGR cooler. Furthermore, a second by-pass can be adopted as well, namely an intercooler by-pass 261 and the related control valve 262. These additional components are controlled in order to accelerate the after-treatment warm-up from an engine cold start, and to increase the engine-out temperature during the DPF regeneration phase as well. In both cases, this would reduce the fuel consumption due to after and post injection and the oil dilution due to post injections as well.

The control strategy starts with the recognition of the engine conditions when after-treatment warm-up is appropriate, depending on DPF regeneration request, or engine coolant temperature. If satisfied, engine-out temperature is compared to target value from a calibratable look-up table, and in case of need, the by-pass for LP-EGR cooler by-pass 327 is activated if the compressor 240 inlet temperature is kept at safe values. Furthermore, a check on the temperature of the intake manifold 200 is performed as well, and the intercooler by-pass 261 is activated in positive case.

The main benefit with respect to using a high pressure EGR circuit is that a LP-EGR circuit does not decrease the flow through the after-treatment system, and does not reduce the air/fuel ratio at the same extent, allowing higher EGR rates to be used. Both effects are beneficial for fastening the after-treatment warm-up.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

1. A method of controlling an internal combustion engine, the internal combustion engine comprising a low pressure EGR cooler by-pass circuit and a control valve, the method comprising the steps of:
determining if a first enabling condition is met; and
controlling an opening of said low pressure EGR cooler by-pass circuit with said control valve if the first enabling condition is met.

2. The method according to claim 1, wherein the internal combustion engine further comprises an intercooler by-pass circuit and a second control valve and the method further comprising the steps of:
determining if a second enabling condition is met; and
controlling the opening of said intercooler by-pass circuit with said second control valve, if the second enabling condition is met.

3. The method according to claim 1, wherein said first enabling condition is active regeneration of a particulate filter.

4. The method according to claim 2, wherein the second enabling condition is an intake manifold temperature below a threshold.

5. An internal combustion engine of an automotive system, the internal combustion engine comprising:
an EGR cooler by-pass circuit;
a control valve; and
a processor configured to control the control valve, the processor further configured to:
determine if a first enabling condition is met; and
control an opening of said EGR cooler by-pass circuit with said control valve if the first enabling condition is met.

6. The internal combustion engine of an automotive system according to claim 5, the internal combustion engine further comprising
an intercooler by-pass circuit; and
a second control valve,
processor further configured to:
determine if a second enabling condition is met; and
control the opening of said intercooler by-pass circuit with said second control valve if the second enabling condition is met.

7. (canceled)

8. (canceled)

9. (canceled)

10. (canceled)

11. The method according to claim 1, wherein said first enabling condition is an inlet oxidation catalyst temperature below an inlet oxidation catalyst temperature target.

12. The method according to claim 1, wherein said first enabling condition is outlet compressor temperature below a threshold.

13. The internal combustion engine according to claim 5, wherein said first enabling condition is active regeneration of a particulate filter.

14. The method according to claim 5, wherein said first enabling condition is an inlet oxidation catalyst temperature below an inlet oxidation catalyst temperature target.

15. The method according to claim 5, wherein said first enabling condition is outlet compressor temperature below a threshold.

16. A non-transitory computer readable medium embodying a computer program product, said computer program product comprising:
a control program for controlling an internal combustion engine that comprises a low pressure EGR cooler by-pass circuit and a control valve, the control program configured to:
determine if a first enabling condition is met; and
control an opening of said low pressure EGR cooler by-pass circuit with said control valve if the first enabling condition is met.

17. The non-transitory computer readable medium embodying the computer program product according to claim 16, wherein the internal combustion engine further comprises an intercooler by-pass circuit and a second control valve, the control program further configured to:
determine if a second enabling condition is met; and
opening said intercooler by-pass circuit with said control valve if the second enabling condition is met.

18. The non-transitory computer readable medium embodying the computer program product according to claim 16, wherein said first enabling condition is active regeneration of a particulate filter.

19. The non-transitory computer readable medium embodying the computer program product according to claim 16, wherein said first enabling condition is active regeneration of a particulate filter.

20. The non-transitory computer readable medium embodying the computer program product according to claim 16, wherein said first enabling condition is an inlet oxidation catalyst temperature below an inlet oxidation catalyst temperature target.

21. The method according to claim 5, wherein said first enabling condition is outlet compressor temperature below a threshold.

22. The method according to claim 6, wherein the second enabling condition is an intake manifold temperature below a threshold.
